(19) United States
(12) Patent Application Publication
(10) Pub. No.: US 2026/0042642 A1
(43) Pub. Date: Feb. 12, 2026

(54) LIFTING TOOL

(71) Applicant: Siemens Gamesa Renewable Energy A/S, Brande (DK)

(72) Inventors: Frederik Jul Bertelsen, Vejle (DK); Rene Kjeldbjerg, Toerring (DK)

(21) Appl. No.: 18/997,552

(22) PCT Filed: Jul. 10, 2023
(86) PCT No.: PCT/EP2023/069081

§ 371 Date: Jan. 22, 2025

(30) Foreign Application Priority Data
Aug. 1, 2022 (EP) 22188080.0

(51) Int. Cl. B66C 1/44; B66C 1/10

(52) U.S. Cl. CPC B66C 1/44; B66C 1/108

(57) ABSTRACT

A lifting tool is provided including a gripping device or grip configured to engage about the shaft of a fastener; a yoke for connecting the lifting tool to a crane hook; and a suspension device or suspension adapted to suspend the gripping device or grip from the yoke such that the gripping device or grip is freely rotatable about a horizontal axis. The disclosure further describes a method of lifting a fastener from a horizontal position to a vertical position using an embodiment of the lifting tool.

### CROSS-REFERENCE TO RELATED APPLICATIONS

This application is a national stage of PCT Application No. PCT/EP2023/069081, having a filing date of Jul. 10, 2023, claiming priority to European Patent Application No. 22188080.0, having a filing date of Aug. 1, 2022, the entire both contents of which are hereby incorporated by reference.

### FIELD OF TECHNOLOGY

The following relates to a lifting tool and method of lifting a fastener from a horizontal position to a vertical position using an embodiment of the lifting tool.

### BACKGROUND

During construction of a large tower such as a wind turbine tower, it can be necessary to join adjacent flanges using fasteners such as bolts, stud bolts etc. For example, a flange at the base of the tower may need to be bolted to an anchor ring of the foundation. Equally, adjacent tower sections may be connected by inserting fasteners into holes of complementary flanges.

The type of flange bolt used to join parts of a tall wind turbine tower can be a stud bolt with a suitable diameter (M64, M80 etc.) and a length in the order of 80 cm. Such a flange bolt can weigh 40 kg or more, and many such flange bolts may be required to connect flanges having diameters in the order of 6.5 m to 9 m. The flange bolts may be delivered on pallets to the base of the tower, and each one must then be raised to flange height. To avoid injury, manual lifting of such heavy objects is avoided. Instead, it is desired to deploy lifting tools to lift a heavy flange bolt from its horizontal storage position, turn it into a vertical position, and lower it vertically into a through-hole of the flange.

In a known approach, a lifting tool comprising a strong electromagnet is used to lift a flange bolt in a two-step procedure. The lifting tool is suspended from a crane hook, and the crane can be operated to raise the hook (and the suspended load) to a higher level. In a first step, the magnet is placed midway along the shaft of a flange bolt resting in a storage unit such as a pallet, and the flange bolt is lifted laterally to an intermediate location where it is briefly “parked” in a position that allows the magnet to be re-positioned, i.e., detached from the shaft and attached to the head of the flange bolt. The crane is then operated to raise the hook, resulting in the flange bolt being “upended” to a vertical position. The crane is then operated to raise the vertically suspended flange bolt to a desired location, for example to a level above a tower flange assembly, and to lower the flange bolt into a through-hole of the flange assembly. The known approach is quite time-consuming owing to the two separate steps and the need for manual adjustment of the magnet position.

Furthermore, fittings of the magnetic tool are generally designed specifically for use with a certain bolt size, for example only for use in lifting M64 bolts. However, a construction project may require large fasteners with different diameters, for example M64 bolts at one connection interface, and heavier M80 bolts at another connection interface. The need to provide more than one magnetic tool adds to the overall cost of construction. This approach is also more time-consuming and hazardous owing to the additional steps of having to disconnect one tool from the crane so that the other tool can be deployed.

### SUMMARY

According to embodiments of the invention, the lifting tool comprises a gripping means (hereinafter reference to gripping means also refers to a gripping device or a grip) configured to engage about the shaft of a fastener; a yoke for connecting the lifting tool to a crane hook; and a suspension means (hereinafter reference to a suspension means also refers to a suspension device or a suspension) adapted to suspend the gripping means from the yoke such that the gripping means is freely rotatable about a horizontal axis. To suspend the gripping means from the yoke such that the gripping means is freely rotatable about a horizontal axis, the suspension means shall be understood to comprise a pair of connection points, diametrically opposed on the gripping means. The suspension means further comprises a pair of connectors, each connector extending between an outer end of the yoke and a connection point. The diametrically opposed connection points define the horizontal axis about which the gripper can rotate.

In an embodiment, the lifting tool can lift the fastener from an initial horizontal storage orientation into a final vertical installation orientation in a single maneuver, i.e., without having to reposition or rearrange the lifting tool. The gripping the lifting tool can be put into place to fit about the shaft of the horizontally lying fastener. As the lifting tool is raised, the suspension means allows the gripping means to tilt, allowing the heavy fastener to assume a vertical position, underneath and essentially in line with the crane hook. In this vertical position, the suspended fastener can be lifted to its intended destination.

According to embodiments of the invention, the method of lifting a fastener from a horizontal position to a vertical position using such a lifting tool comprises the steps of engaging the gripping the lifting tool about the shaft of the horizontally oriented fastener; attaching the yoke of the lifting tool to a crane hook; and operating the crane to raise the lifting tool to a height at which the weight of the fastener causes the gripping means to rotate about its horizontal axis, allowing the fastener to assume a vertical orientation.

In an embodiment, the number of handling steps is minimized during a fastener lifting maneuver. The gripping means need only be positioned once and does not need to be repositioned at any time during the lifting maneuver. The gripping means is placed onto the fastener in its initial horizontal storage position and does not need to be manipulated again until it is to be removed from the final vertical installation position of the fastener. In this way, the lifting tool contributes to compliance with workplace health and safety regulations.

In the following, it may be assumed that the lifting tool is deployed to lift wind turbine tower flange fasteners from storage near the base of the tower to the level of a tower flange. Furthermore, it may be assumed that a crane such as a telescopic boom crane is deployed to hoist the load (i.e., the lifting tool and flange bolt) from its initial position to a higher, final position.

In an embodiment, the flange bolt is a threaded rod, also referred to as a stud or stud bolt, dimensioned for insertion through holes of a wind turbine tower flange. Nuts threaded onto the ends of the stud bolt are used to create tension, i.e., to tighten the flange connection. In a further embodiment, a stud bolt can be a tap-end stud bolt, a double-end stud bolt, a fully-threaded stud bolt, etc. A stud bolt for connecting wind turbine tower flanges can have a diameter in the order of 64 mm or more, and a length in order of 80 cm. In the following, it shall be understood that the weight of such a stud bolt can be 40 kg or more.

A stud bolt is a fastener without a head, instead a nut is threaded onto each (usually chamfered) end and turned using a wrench. Heavy studs of the type used to connect wind turbine tower flanges may be delivered with a nut already in place at the “upper end”, so that the stud can be dropped into place into the flange holes. The lower nut can then be threaded onto the downward-pointing end of the stud.

The gripping means is realized to grip the shaft of a stud bolt during the lifting maneuver, and may be referred to as a “gripper” in the following. The gripper is dimensioned to engage about a shaft with a diameter of at least 56 mm, i.e., to hold at least an M56 stud. The gripper can be constructed in any suitable way. In an embodiment of the invention, the gripping means comprises a first jaw and a second jaw rotatably connected to the first jaw. For example, the jaws can be connected by a pivot hinge, allowing the jaws to be opened so that the gripper can be put into place about a stud or removed from a stud. The gripper is constructed so that when the jaws are “closed”, the gripper makes good contact with the stud bolt shaft.

In an embodiment of the invention, the gripper is constructed to comprise a locking means to secure the jaws in their “closed” position. The locking means can be realized in any suitable manner, for example a band can be wrapped about the jaws after placing the gripper about the shaft of a stud. In an embodiment of the invention, the locking means is realized as a cam-action indexing plunger. In an embodiment, the locking means is arranged near the hinge between the jaws, so that the locking means can be easily accessed during the initial stage of placing the gripper about the shaft of a horizontal bolt, i.e., there is no need for a worker to reach into the possibly confined space between or underneath the heavy flange bolts lying on a pallet in order to manipulate any locking means. In an embodiment, the gripper jaws are constructed so that the body of the locking means is attached to one jaw, and the plunger can extend into a matching hole formed in the other jaw when the gripper is in place about a stud shaft. This configuration allows the gripper to be locked and unlocked very quickly and also ensures that the gripper remains locked until the plunger is released.

As explained above, it can be necessary to lift fasteners with different shaft diameters. Therefore, in an embodiment of the invention, the gripper is provided with a diameter adjustment means (hereinafter reference to diameter adjustment means also refers to a diameter adjustment device) which is realized to adjust the working diameter of the gripping means between a first load diameter and a second load diameter. The term “working diameter” shall be understood as the diameter of the largest circle that would fit between the gripper jaws in their “closed” position. The diameter adjustment means can be realized in any suitable manner, for example by providing pairs of curved arms, each pair shaped to fit about a fastener with a certain diameter, and attaching the curved arms of a suitable pair to the gripper jaws prior to a lifting procedure.

In an embodiment of the invention, the diameter adjustment means is realized as a pair of rotatable curved arms. Each curved arm is seated on a gripper jaw and secured by a pivot joint. In a default position, a curved arm is aligned with its gripper jaw. The diameter adjustment means also includes a position setter for each curved arm, so that a curved arm can be rotated to a different working position in which one end of the curved arm extends into the space between gripper jaws, thereby reducing the working diameter of the gripper. In an embodiment of the invention, a position setter comprises a longitudinal slit in a gripper jaw, and a fastener to fix the corresponding rotatable curved arm at the chosen position. The diameter adjustment means allows the gripper to be used to lift stud bolts with a range of diameters, for example between 54 mm (M54) and 80 mm (M80). In an embodiment, the rotatable curved arms are formed by injection-molding a synthetic polymer such as polyoxymethylene (POM), which has favorable properties such as high stiffness and low friction.

The suspension means allow the gripper to be suspended from the yoke or crane link in such a way that the gripper is freely rotatable about a horizontal axis. This can be achieved in a number of ways, for example the gripper and yoke can be connected by a pair of vertically extending arms that terminate in pivot joints. Equally, the suspension means can be realized by constructing the crane link as a type of shackle and constructing each gripper jaw to comprise one end of a “clevis pin”.

The diametrically opposed connection points on the gripper can be realized in any suitable fashion. In an embodiment of the invention, the connection points are eyelets on either side of the gripper, and a chain extends vertically between each eyelet and an outer end of the yoke. Instead of a chain, a suitable wire, rope or cable could be used. The inherent flexibility of a chain, rope or cable allows the jaws of the gripper to be moved apart or spread to facilitate placement of the gripper about a bolt shaft, and to facilitate removal of the gripper from the bolt shaft. The yoke or crane link is at least as wide as the gripper. The diametrically opposed eyelets define the horizontal axis of rotation of the gripper. Connecting such a chain, rope or cable to the gripper through eyelets ensures that the gripper can freely rotate about that horizontal axis. In an embodiment of the invention, the eyelets are arranged near or on a line extending through the diameter of a stud shaft enclosed by the gripper. With this favorable configuration, the gripper's horizontal axis of rotation coincides with a diameter of the stud, allowing the center of mass of the load to lie essentially directly under the crane hook. The heavy stud can therefore be lifted from its horizontal storage position to its vertical installation position in one smooth movement.

The method comprises a preparatory step of arranging two nuts onto the “upper end” of the stud shaft, with enough space between the first nut and the second nut to accommodate the gripper with some ease. In a first step, the gripper is put into position about the stud shaft between the two nuts, and the lock is actuated to hold the gripper jaws in the “closed” position. The crane is then actuated to raise the lifting tool, thereby gradually lifting the stud from its horizontal position. As the lifting tool is raised, the weight of the stud held by gripper causes the gripper to tilt, allowing the stud to assume a vertical position with its center of mass essentially underneath the crane hook. In this vertical position, the stud is raised to the flange and the crane is actuated to guide the stud into a flange hole. After lowering the stud into a flange hole, the weight of the stud is carried by the lower nut. It is then straightforward to remove the gripper from between the upper and lower nuts. The upper nut can then be removed and placed onto the lower end of the stud in preparation for a bolt tightening procedure.

### BRIEF DESCRIPTION

Some of the embodiments will be described in detail, with references to the following Figures, wherein like designations denote like members, wherein:

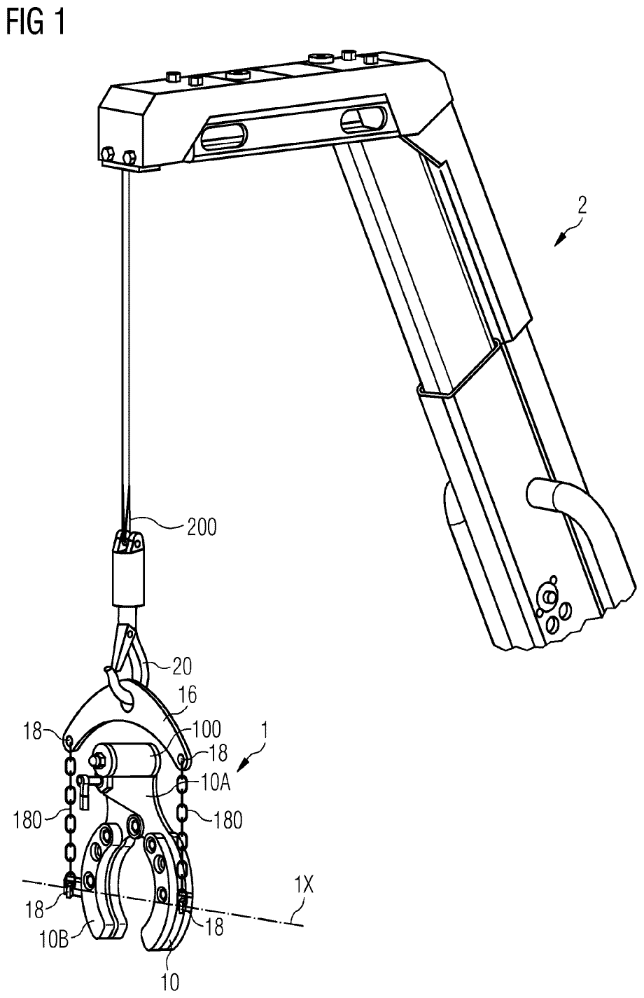

FIG. 1 shows an exemplary embodiment of the lifting tool;

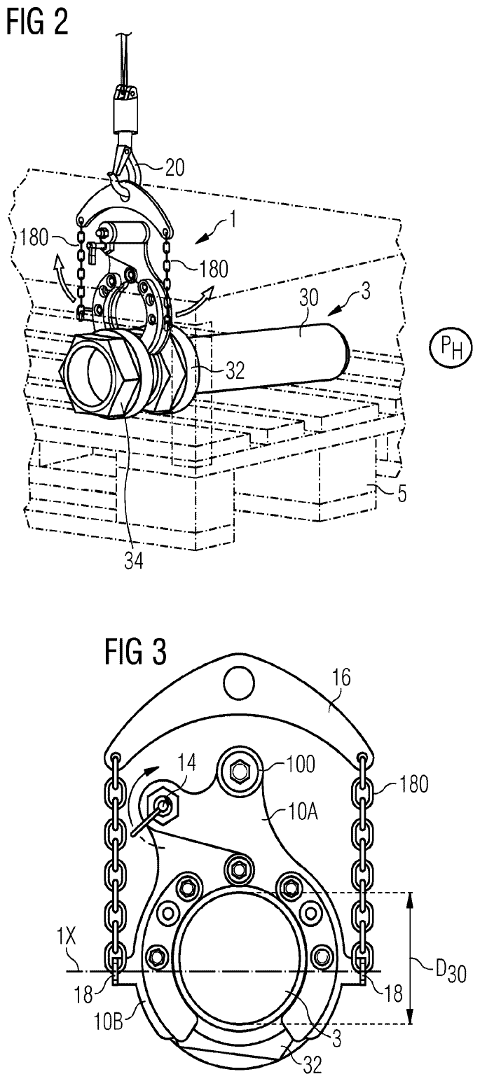

FIG. 2 shows a stage in a lifting procedure using an embodiment of the lifting tool;

FIG. 3 shows a further stage in a lifting procedure using an embodiment of the lifting tool;

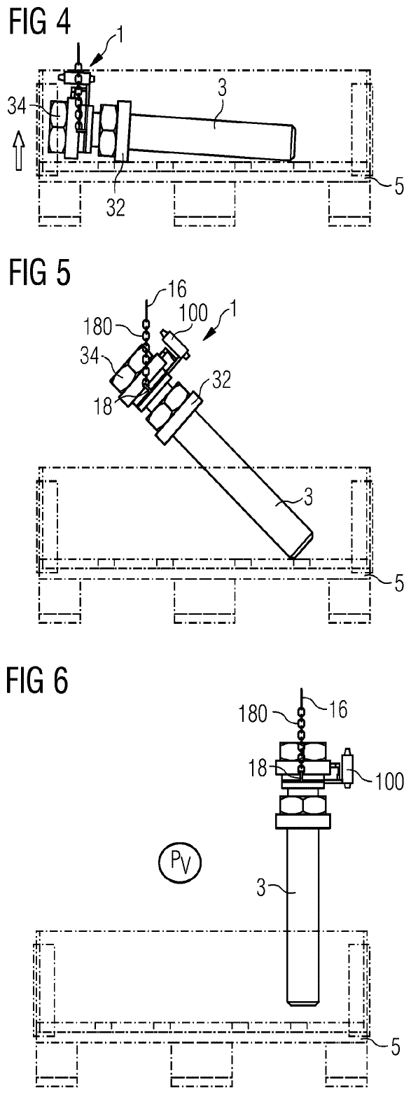

FIG. 4 shows a further stage in a lifting procedure using an embodiment of the lifting tool;

FIG. 5 shows a further stage in a lifting procedure using an embodiment of the lifting tool;

FIG. 6 shows a further stage in a lifting procedure using an embodiment of the lifting tool;

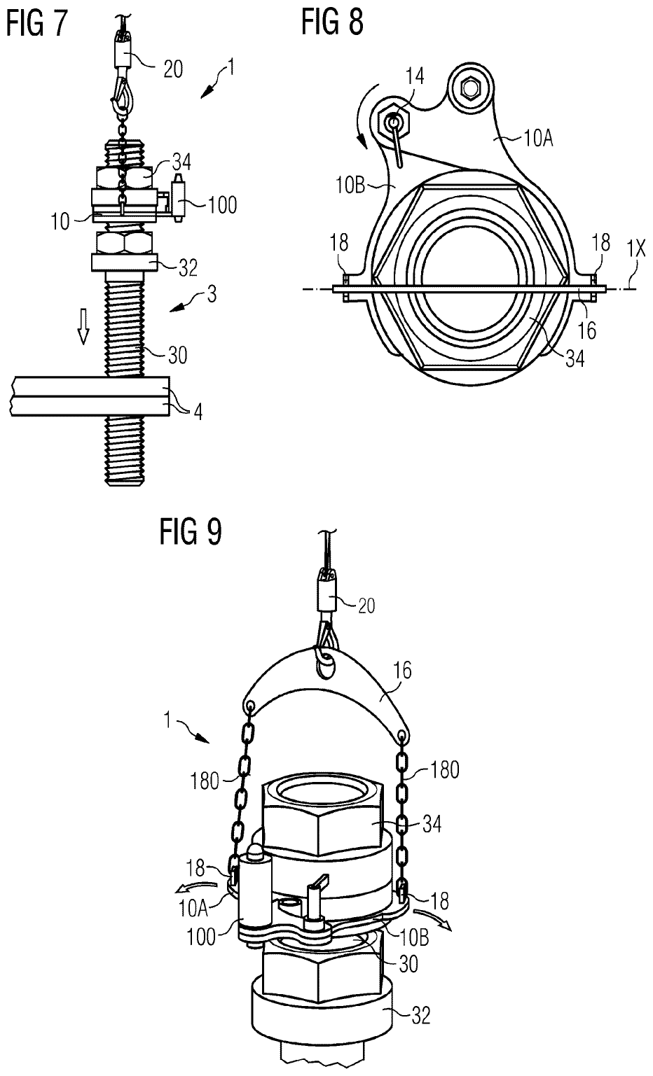

FIG. 7 shows a further stage in a lifting procedure using an embodiment of the lifting tool;

FIG. 8 shows a further stage in a lifting procedure using an embodiment of the lifting tool;

FIG. 9 shows a further stage in a lifting procedure using an embodiment of the lifting tool;

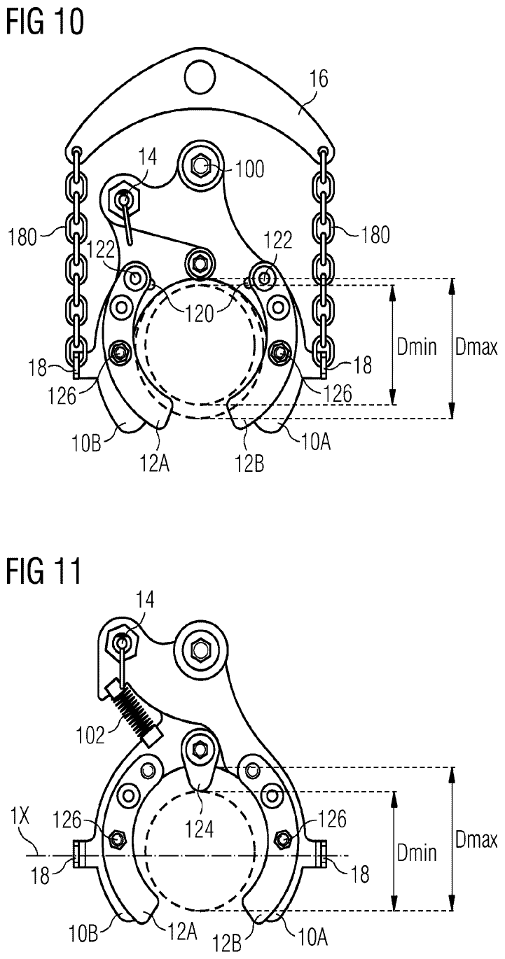

FIG. 10 shows an embodiment of the lifting tool

FIG. 11 shows an embodiment of the lifting tool; and

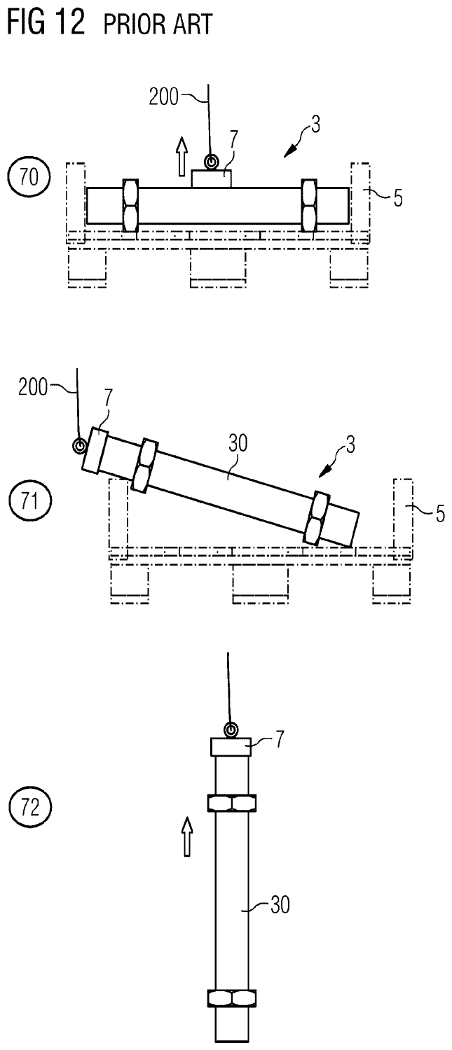

FIG. 12 illustrates a conventional bolt lifting procedure.

### DETAILED DESCRIPTION

FIG. 1 shows an exemplary embodiment of the lifting tool 1. The lifting tool 1 comprises a gripper 10 with a pair of jaws 10A, 10B connected in this example by a pivot hinge 100. A yoke 16 allows the lifting tool 1 to be suspended from the hook 20 and cable 200 of a crane 2 as indicated. The gripper 10 is freely suspended from the yoke 16 by a pair of chains 180, one on each side of the gripper 10. The upper end of each chain 180 attaches to the yoke 16 through an eyelet 18, and the lower end of each chain 180 attaches to the gripper 10 through an eyelet 18.

FIGS. 2-9 show stages in a lifting procedure using an embodiment of the lifting tool. In a first stage as shown in FIG. 2, the gripper 10 is put into place about the shaft 30 of a flange bolt 3. Here, a flange bolt 3 is shown resting horizontally on a pallet 5. A worker can manually open the jaws 10A, 10B of the gripper 10 to allow this to fit about the shaft 30, as indicated by the arrows. The worker can then lock the gripper 10 as shown in FIG. 3 (which shows a cross-section taken between the upper nut and the lifting tool), by actuating the lock 14 to prevent the jaws 10A, 10B from moving, as indicated by the curved arrow. Here, the lock 14 is realized as a cam-action indexing plunger. Turning the lever of the lock 14 causes a pin to extend into a corresponding hole of the left-hand jaw 10A, so that it can no longer move relative to the right-hand jaw 10B. This diagram indicates the working diameter D30 of the lifting tool 1, i.e., the diameter D30 of the stud 3.

The crane is then operated to raise the lifting tool 1 so that the “upper end” of the stud 3 is raised upward as indicated in FIG. 4 and FIG. 5. The weight of the flange bolt 3 causes the gripper 10 to tilt progressively about its horizontal axis 1X. By the time the stud 3 leaves solid ground (its lower end is no longer in contact with the pallet), its weight causes it to assume an essentially vertical position as shown in FIG. 6, and the gripper 10 is essentially horizontal. In FIG. 7, the vertically suspended flange bolt 3 has been raised to a tower flange assembly and is being lowered through matching holes of a pair of tower flanges 4. Once the lower nut 32 of the flange bolt 3 rests on the flange surface, the gripper 10 can be opened by actuating the lock as indicated in FIG. 8, which shows a plan view from above. Releasing the lock 14 allows the gripper jaws 10A, 10B to be opened, so that the lifting tool 1 can be removed from the flange bolt 3 as indicated in FIG. 9, i.e., a worker can manually open the jaws 10A, 10B of the gripper 10 to allow it to be removed from about the shaft 30, as indicated by the arrows.

The steps of placing the gripper about the bolt shaft (as shown in FIG. 2) and removing it again (as shown in FIG. 9) can be facilitated by leaving a gap between the lower nut 32 and the upper nut 34 that is slightly larger than the height of a jaw and curved arm. A suitably sized gap is shown in FIG. 7.

FIG. 10 shows a further exemplary embodiment of the lifting tool 1 in which the gripper 10 can be adjusted for use with loads having different diameters. To this end, a diameter adjustment means 12 is provided. In this embodiment, the diameter adjustment means 12 is realized as a pair of rotatable curved arms 12A, 12B and a pair of position setters 120, 122. Each rotatable arm 12, 12B can pivot about a connector 126 such as a metal screw. Each position setter comprises a longitudinal slit 120 in a gripper jaw, and a fastener 122 to fix its rotatable curved arm at the chosen position. The diameter adjustment means 12 allows the gripper 10 to be used for loads having diameters within a certain range Dmin-Dmax as indicated in the diagram. For example, the gripper 10 and the diameter adjustment 12 can be realized for flange bolt diameters between 54 mm (M54) and 80 mm (M80).

FIG. 11 shows a further exemplary embodiment of the lifting tool 1. This embodiment illustrates two further features which can be realized independently of each other in any of the embodiments described above. Here, a bias spring 102 is arranged between the jaws 10A, 10B of the gripper 10. The bias spring acts to keep the gripper 10 in its closed position, as an additional safety measure during the lifting sequence.

The second feature illustrated in the diagram is an alternative diameter adjustment means 12, realized as a rotatable nose 124. In its first end position as indicated by the dotted line, the nose 124 allows the gripper 10 to fit about the largest flange bolt diameter Dmax. In its second end position as indicated here, the nose 124 ensures that the gripper 10 will fit about the smallest flange bolt diameter Dmin. Intermediate diameters can be “set” by turning the nose 124 by an appropriate amount. The position of the nose 124 is fixed by tightening a screw 122 as shown here.

FIG. 12 illustrates a conventional approach to lifting a heavy flange bolt. In a first stage illustrated on the left, an electromagnet 7, suspended from a crane, is placed on the shaft 30 of a bolt 3 resting in an initial horizontal storage orientation 70. The bolt 3 is then lifted to an intermediate orientation 71 in which the head of the bolt 3 is freely accessible as indicated in the middle. The electromagnet 7 is then detached from the shaft 30 and re-attached to the bolt head. The bolt 3 can then be raised into a vertical position 72 as indicated on the right, and subsequently lifted to the level of the flange. This procedure is time-consuming on account of the various steps involved. Furthermore, a power supply is required to activate and deactivate the electromagnet 7. Because of the strong magnetic field created during activation of the electromagnet 7, additional safety requirements must be adhered to in order to avoid injury to personnel.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A lifting tool comprising
a grip configured to engage about the shaft of a fastener;
a yoke for connecting the lifting tool to a crane hook; and
a suspension adapted to suspend the grip from the yoke such that the grip is freely rotatable about a horizontal axis.

2. A lifting tool according to claim 1, wherein the suspension comprises a pair of eyelets on either side of the grip and a chain extending from each eyelet to an outer end of the yoke.

3. A lifting tool according to claim 1, wherein the horizontal axis extends through the eyelets and essentially coincides with a diameter of a fastener shaft enclosed by the grip.

4. A lifting tool according to claim 1, wherein the grip is dimensioned to engage about a cylindrical shaft with a diameter of at least 54 mm.

5. A lifting tool according to claim 1, wherein the grip comprises a first jaw and a second jaw rotatably connected to the first jaw.

6. A lifting tool according to claim 1, comprising a diameter adjustment for adjusting a working diameter of the grip.

7. A lifting tool according to claim 1, wherein the grip comprises a non-slip material arranged to lie against the surface of the fastener.

8. A lifting tool according to claim 1, comprising a lock configured to secure the position of the second jaw relative to the first jaw.

9. A lifting tool according to claim 1, wherein the lock is a cam-action indexing plunger.

10. A lifting tool according to claim 1, adapted for use in lifting a fastener with weight of at least 40 kg.

11. A method of lifting a fastener from a horizontal position to a vertical position using a lifting tool according to an claim 1, which method comprises the steps of
engaging the grip of the lifting tool about the shaft of the horizontally oriented fastener;
attaching the yoke of the lifting tool to a crane hook; and
operating the crane to raise the lifting tool to a height at which the weight of the fastener causes the grip to rotate about its horizontal axis, allowing the fastener to assume the vertical position.

12. A method according to mclaim 11, comprising a preparatory step of arranging a first nut and a second nut onto one end of the fastener shaft, with a gap between the first nut and the second nut to accommodate the grip.

13. A method according to claim 11, wherein the lifting tool is deployed to lift a wind turbine tower flange fastener from ground level to the level of a tower flange.

14. A method according to claim 11, comprising a step of operating the crane to lower the fastener shaft vertically into a flange through-hole.

15. A method according to claim 11, comprising a step of actuating the lock to release the grip from the fastener shaft.
